(19) United States
(12) Patent Application Publication
(10) Pub. No.: US 2009/0073938 A1
(43) Pub. Date: Mar. 19, 2009

(54) METHOD, SYSTEM AND APPARATUS FOR OPTIMIZING CALL ANCHORING IN VOICE CALL CONTINUITY

(75) Inventors: Dongming Zhu, Shenzhen (CN); Jie Xu, Shenzhen (CN); Xiaoqin Duan, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/258,605

(22) Filed: Oct. 27, 2008

Related U.S. Application Data
(63) Continuation of application No. PCT/CN2007/000490, filed on Feb. 12, 2007.

(30) Foreign Application Priority Data
Apr. 27, 2006 (CN) 200610074551.8
Jul. 28, 2006 (CN) 200610099532.0

(51) Int. Cl. H04W 36/00

(52) U.S. Cl. 370/331

(57) ABSTRACT

The present invention provides a method and system for optimizing call anchoring in VCC, a VCC anchoring optimization function entity, and a routing control entity, with a view to correlating the call anchoring with the processing of a service potentially influential in anchoring a call. The method includes: the VAO function entity perceives the service information of a called party; and the VAO function entity optimizes the call anchoring when determining that the service subscribed to by the called party may affect anchoring of the current call. The present invention enables correlation between the call anchoring and the processing of the service influential in anchoring the call, and optimizes the call anchoring.

### FIELD OF THE INVENTION

The present invention relates to the field of wireless communications, and in particular, to a method, system and apparatus for optimizing call anchoring in voice call continuity.

### BACKGROUND OF THE INVENTION

Voice Call Continuity (VCC) is an application service provided in a home IMS network of a user to enable bidirectional handover of a voice call between the Circuit Switched (CS) domain and the IP Multimedia Subsystem (IMS) network. An integrated IMS architecture (in which different IP access technologies are integrated through an IMS network) makes it possible to initiate GSM voice calls under Wireless Local Area Network (WLAN) coverage. If seamless voice call services are implemented in the CS domain and IP-CAN, including WLAN, and various Radio Access Networks (RANs), the load of GSM/UMTS wireless resources will be relieved, and the revenues of operators will be increased. Besides, a fixed network operator that provides VoIP services can also benefit from providing integrated services through a 3GPP IMS architecture.

At the terminal side, domain handover can be initiated when a VCC terminal is performing one or more voice sessions. At the network side, to enable the domain handover function of a VCC terminal, the calls initiated or received by a VCC user must be anchored to the Call Continuity Control Function (CCCF) entity of the home IMS network of the user. The CCCF handles the domain handover initiated by the anchored VCC user, and releases the call handed over from the domain upon completion of handover. When a VCC terminal is registered in a CS domain and an IMS domain concurrently, the network needs to select a domain for routing the call when handling an incoming call. The selection is performed by a Network Domain Selection (NeDS) entity. The domain is selected according to the policies of an operator, the preference of a user, the capability of a terminal, and the capability of an IP-CAN in bearing real-time voice services. Generally, the CCCF and the NeDS are provided together.

“CCCF/NeDS” is used hereinafter to represent the control entity that provides VCC services in an IMS network (namely, VCC function entity). A VCC function entity includes the functions of the CCCF/NeDS and other functions required for implementing VCC services. The CCCF/NeDS occupies the position of an application server in an IMS network, and occupies the position of an intelligent Service Control Point (SCP) in a CS network, thus playing a role in the IMS network and a role in the CS network concurrently.

In the 3GPP technology, it is a trend to generalize the NeDS, that is, multiple services or applications use the functions of an NeDS. The 3GPP has special topics to research the generalized NeDS technology. In this way, the NeDS may serve as an independent application server in the IMS network to provide services for various applications. As a result, the NeDS needs be separated from other functions of the VCC, and they should communicate through a standard interface.

Early forwarding is a Call Forwarding (CF) service defined by the 3GPP, in which the Home Location Register (HLR) or Home Subscriber Server (HSS) of the called party returns the forwarding information. Examples of early forwarding are: Call Forwarding Unconditional (CFU), and Call Forwarding on Mobile Subscriber Not Reachable (CFNRc). Early forwarding is generally handled at the Gateway Mobile Switching Center (GMSC) of the called party. In the 3GPP2, early forwarding is not defined explicitly, but early forwarding is also applicable owing to similar processing mechanisms, e.g. CFU, Call Forwarding on Mobile Subscriber Busy (CFB), and CFNRc.

Currently, the VCC group of the 3GPP puts forward the following four solutions to call forwarding in the scenarios where a VCC user is a called party and the NeDS chooses to route the call in the CS domain:

### Solution 1

The call enters the NeDS through an IMS network, and the NeDS obtains the roaming number of the user in the CS domain directly. As shown in FIG. 1, this process includes the following steps:

1. The CCCF/NeDS receives an INVITE message of an incoming call and begins to anchor the call.

2. If the CCCF/NeDS determines that the call needs to be routed in the CS domain, the CCCF/NeDS obtains the roaming number of the user in the CS domain from the home HSS of the user.

3. According to the current location of the user in the CS domain, the HSS obtains the roaming number from the Visited Mobile Switching Center (VMSC).

4. The VMSC allocates a roaming number of the CS domain to the incoming call, and sends the roaming number to the HSS.

5. The HSS returns the roaming number to the Mobile Subscriber Roaming Number (MSRN) allocated by the CCCF/NeDS.

6. The CCCF/NeDS uses the roaming number to route the call to the VMSC of the CS domain for further processing.

7. If the called VCC user has subscribed to the early forwarding service of the CS domain, the HSS returns the forwarded-to number after receiving Send Routing Information (SRI), and notifies the CCCF/NeDS to handle the call forwarding. At this moment, the CCCF/NeDS has begun call anchoring, and the anchoring for the VCC user is ineffective after call forwarding.

### Solution 2

The call enters the NeDS through an IMS network, and the solution is based on signaling interception (using an SRF<VCC-SRF> inside a VCC function entity to intercept the SRI signaling). As shown in FIG. 2, the process includes the following steps:

1-4. If the CCCF/NeDS determines that the call could be handled in the CS domain through the NeDS, the CCCF allocates a routing number “CSRN” for routing the call to the CS domain, and anchors the call. The CCCF routes the call back to the Serving-Call Session Control Function (S-CSCF), and the S-CSCF routes the call to the GMSC through a Media Gateway Control Function (MGCF).

59. Based on the configuration of the operator, the GMSC uses the CSRN as a Mobile Station International ISDN Number (MSISDN), and puts the CSRN into the SRI message which is sent to the HSS to obtain the roaming information. When the SRI message passes through the CCCF/NeDS, the CCCF/NeDS intercepts the message. In the message, if the CCCF/NeDS finds the routing number allocated by the CSRN to the CCCF/NeDS, the CCCF/NeDS returns the true MSISDN to the HSS for further processing. According to the received MSISDN, the HSS obtains the MSRN from the VMSC, and returns the obtained MSRN to the CCCF/NeDS through an SRI ACK message. The CCCF/NeDS sends an SRI ACK message to the GMSC, with the MSRN carried in the message. After obtaining the MSRN, the GMSC routes the call to the VMSC.

In the case of early forwarding, the HSS returns the forwarded-to number directly after step 6. The call of the VCC user is already anchored to the CCCF/NeDS before being forwarded to another user. Consequently, the call anchoring at the CCCF is ineffective.

### Solution 3

The call enters the NeDS through a CS domain. The solution is based on Customized Applications for Mobile Network Enhanced Logic (CAMEL). As shown in FIG. 3, the process includes the following steps:

1-6. After the call of the CS domain arrives at the GMSC, the CAMEL service triggers judgment made by the NeDS. If the CCCF/NeDS determines that the call needs to be routed in the CS domain, the CCCF/NeDS allocates a call reference number and a Public Service Identifier (PSI) of the CCCF/NeDS. The call reference number combines with the PSI into an IMS network roaming number (IMRN). According to the IMRN, the GMSC routes the call to the IMS domain.

7-10. The GMSC routes the call to the IMS network according to the IMRN. The IMS network finds the CCCF/NeDS according to the PSI information.

11-13. According to the call reference number, the CCCF/NeDS releases the IMRN, finds the original called party, finishes anchoring the call in the CCCF, and allocates a CSRN to route the call to the CS domain.

14-20. The GMSC replies with an MSISDN according to the CSRN, and sends an SRI message to the HSS to obtain the roaming information. After the CAMEL is triggered, the NeDS determines that the anchoring is finished, and returns a Continue message so that the GMSC continues processing. In this way, the GMSC can obtain the MSRN of the called party in the CS domain.

21-22. According to the MSRN, the GMSC routes the call to the CS domain for further processing.

In the case of early forwarding, the early forwarding cannot be triggered in steps 3-7 due to number change in the intelligent network, but can be triggered in step 17. In step 17, the call of the VCC user has been anchored to the CCCF/NeDS, but the call is forwarded to another user. Consequently, the call anchoring is ineffective.

### Solution 4

The call enters the NeDS through a CS domain, and the solution is based on signaling interception (using a built-in VCC-SRF to intercept the SRI signaling). As shown in FIG. 4, the process includes the following steps:

1-4. The CCCF/NeDS (built-in VCC-SRF) intercepts the SRI message sent by the GMSC to the HSS. After determining that the call needs to be anchored to the IMS and handled in the CS domain, the CCCF/NeDS allocates a call reference number, which combines with the PSI of the CCCF to generate an IMRN; the IMRN is carried in the SRI ACK message, and returned to the GMSC.

5-8. The GMSC routes the call to the IMS network according to the IMRN. The IMS network analyzes the IMRN, and finds the CCCF/NeDS according to the PSI information in the IMRN.

9-11. The CCCF/NeDS finishes anchoring, and allocates a CSRN to route the call back to the GMSC of the CS domain for further processing.

12-13. According to the configuration of the operator, the GMSC requests roaming information from the HSS by using the CSRN as an MSISDN. When the roaming information passes through the CCCF/NeDS, the VCC-SRF intercepts the information; after detecting that the CSRN is the routing number allocated by the CCCF/NeDS, the CCCF/NeDS returns the true MSISDN to the HSS.

14-16. The HSS returns the MSRN to the GMSC for further processing according to the corresponding process of the CS domain.

17. The GMSC routes the call to the local VMSC according to the MSRN, thus finishing the call routing in the CS domain.

In the case of early forwarding, the early forwarding is triggered after step 16. The call is already anchored to the CCCF/NeDS before being forwarded to another user. Consequently, the call anchoring at the CCCF is ineffective.

Obviously, the following weaknesses are discovered in the prior art:

1. The early forwarding service forwards a call to other users, which makes the completed call anchoring ineffective. Therefore, the system is unable to know whether the completed call anchoring is effective, and thus unable to optimize the call anchoring pertinently.

2. If the ineffective call anchoring is held but new calls need to be routed to the called party of the anchored call, the CCCF/NeDS refers to the routing domain of the forwarded call, which leads to an error of the domain selection decision.

3. If the ineffective call anchoring is still held, the CCCF/NeDS is unable to know that domain handover cannot be initiated for the forwarded call.

As can be seen from the above, in the prior art, therefore, the call anchoring is not related to the processing of the service that affects the call anchoring, and the system is unable to know whether the completed call anchoring is effective.

### SUMMARY OF THE INVENTION

The present invention provides a method and system for optimizing call anchoring in voice call continuity (VCC), a VCC anchoring optimization function entity, and a routing control entity, with a view to correlating the call anchoring with the processing of a service potentially influential in anchoring a call.

A method provided in an embodiment of the present invention includes:

A. by a VCC Anchoring Optimization (VAO) function entity, perceiving the service information of a called party; and

B. by the VAO function entity, optimizing the call anchoring when determining that the service subscribed to by the called party may affect anchoring of the current call.

A VAO function entity provided in an embodiment of the present invention includes:

a perceiving module, adapted to obtain the service information of a called VCC user;

a judging module, adapted to judge whether a service potentially influential in anchoring a call can be triggered; and

an anchoring optimization module, adapted to optimize the call anchoring according to the judgment result output by the judging module.

A routing control entity provided in an embodiment of the present invention includes: a redirecting module, adapted to reroute a call according to a received redirection message.

A system for optimizing call anchoring in VCC provided in an embodiment of the present invention includes: a routing control entity and a VCC function entity which are connected through a first interface; a VCC function entity and a Home Subscriber Server (HSS) which are connected through a second interface; a VAO function entity, which interacts with the VCC function entity to obtain the service information of a called party and optimize the call anchoring according to the state of a service potentially influential in anchoring a call.

The present invention perceives the service information of a called party through a VAO function entity, and optimizes the call anchoring when the service subscribed to by the called party is potentially influential in anchoring the current call. Therefore, the call anchoring is correlated to the service potentially influential in anchoring the call, and the anchoring can be performed pertinently.

### BRIEF DESCRIPTION OF THE DRAWINGS

FIG. 1 is a flowchart of the first solution in the prior art in the case that a VCC user is a called party and the NeDS chooses to route the call in the CS domain;

FIG. 2 is a flowchart of the second solution in the prior art in the case that a VCC user is a called party and the NeDS chooses to route the call in the CS domain;

FIG. 3 is a flowchart of the third solution in the prior art in the case that a VCC user is a called party and the NeDS chooses to route the call in the CS domain;

FIG. 4 is a flowchart of the fourth solution in the prior art in the case that a VCC user is a called party and the NeDS chooses to route the call in the CS domain;

FIG. 5 shows the structure of a system according to an embodiment of the present invention;

FIG. 6 is the first schematic diagram of the internal structure of a VAO function entity according to an embodiment of the present invention;

FIG. 7 is the second schematic diagram of the internal structure of a VAO function entity according to an embodiment of the present invention;

FIG. 8 shows the internal structure of a routing control entity according to an embodiment of the present invention;

FIG. 9 is a flowchart of the method according to an embodiment of the present invention;

FIG. 10 is a flowchart of the method for optimizing call anchoring in voice call continuity according to a first embodiment of the present invention;

FIG. 11 is a flowchart of the method for optimizing call anchoring in voice call continuity according to a second embodiment of the present invention;

FIG. 12 is a flowchart of the method for optimizing call anchoring in voice call continuity according to a third embodiment of the present invention;

FIG. 13 is a flowchart of the method for optimizing call anchoring in voice call continuity according to a fourth embodiment of the present invention;

FIG. 14 is a flowchart of the method for optimizing call anchoring in voice call continuity according to a fifth embodiment of the present invention;

FIG. 15 is a flowchart of the method for optimizing call anchoring in voice call continuity according to a sixth embodiment of the present invention;

FIG. 16 is a flowchart of the method for optimizing call anchoring in voice call continuity according to a seventh embodiment of the present invention;

FIG. 17 is a flowchart of the method for optimizing call anchoring in voice call continuity according to a eighth embodiment of the present invention;

FIG. 18 is a flowchart of the method for optimizing call anchoring in voice call continuity according to a ninth embodiment of the present invention; and

FIG. 19 is a flowchart of the method for optimizing call anchoring in voice call continuity according to a tenth embodiment of the present invention.

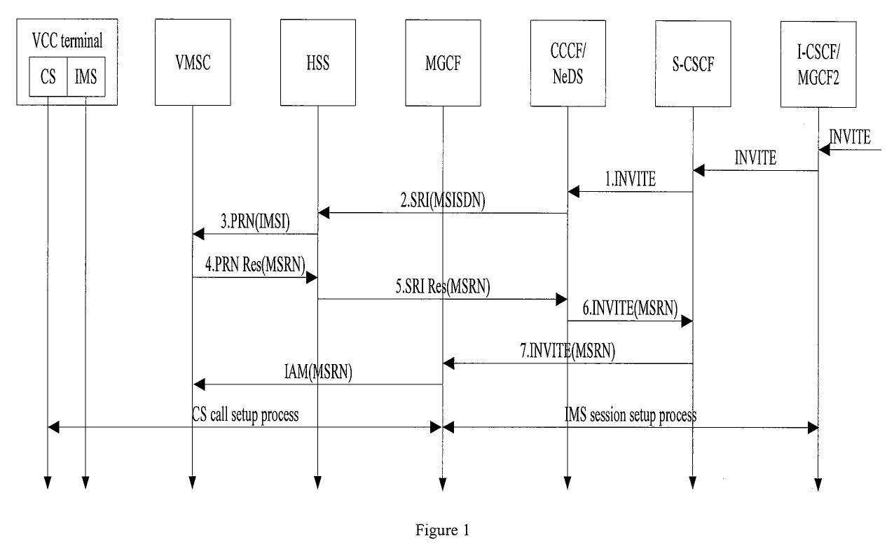

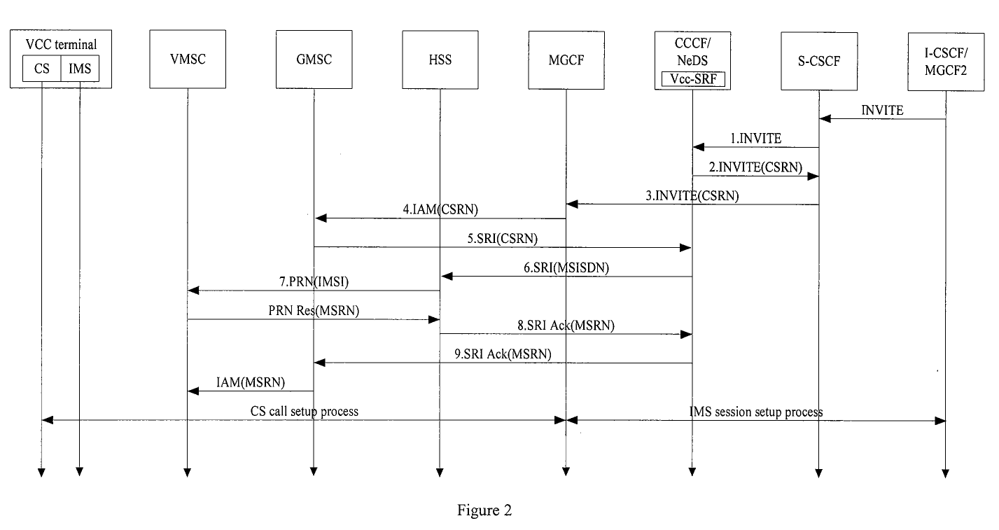

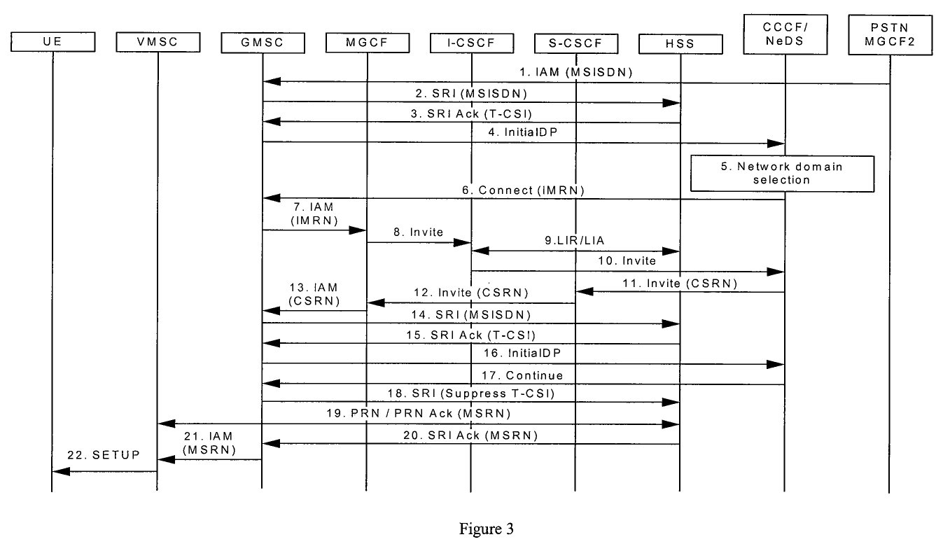

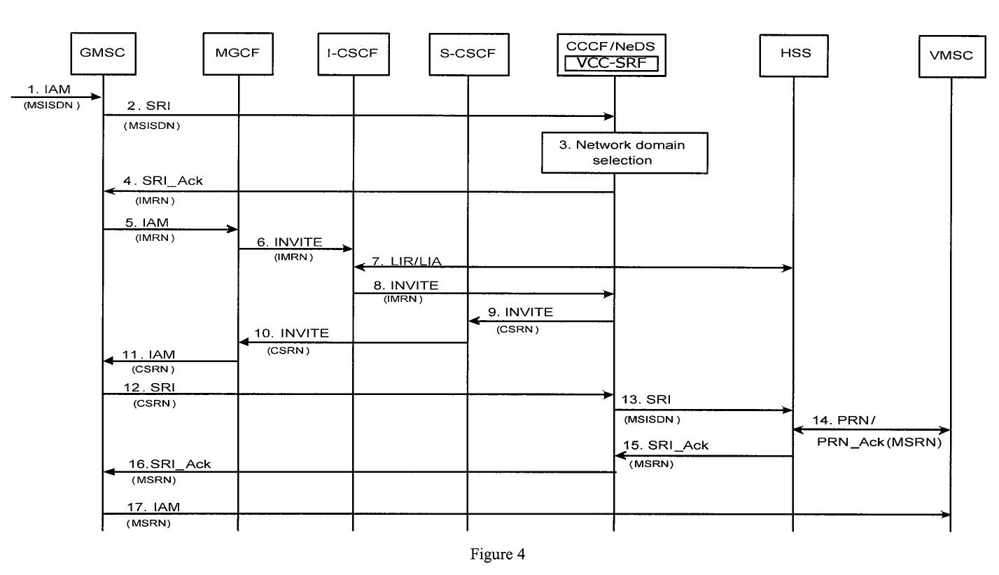

### DETAILED DESCRIPTION OF THE EMBODIMENTS

To optimize the call anchoring and avoid domain selection decision error and domain handover of forwarded calls, an embodiment of the present invention provides a system for optimizing call anchoring in VCC. As shown in FIG. 5, the system includes: a VCC function entity, a VAO function entity which interacts with the VCC function entity, a routing control entity which interacts with the VCC function entity through a first interface, and a VCC function entity which interacts with the VCC function entity through a second interface.

(I) The VAO function entity is included in the VCC function entity, or is independent of and interacts with the VCC function entity, and is adapted to obtain the service information of a called party, and optimize the call anchoring according to the state of a service potentially influential in anchoring a call.

Further, the VAO function entity in this embodiment includes a perceiving module, a judging module and an anchoring optimization module that are connected in sequence.

The perceiving module is adapted to obtain the service information of a called party.

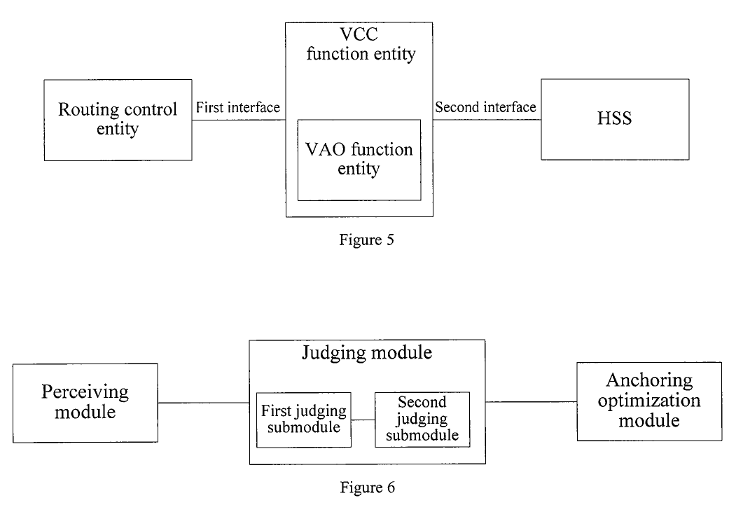

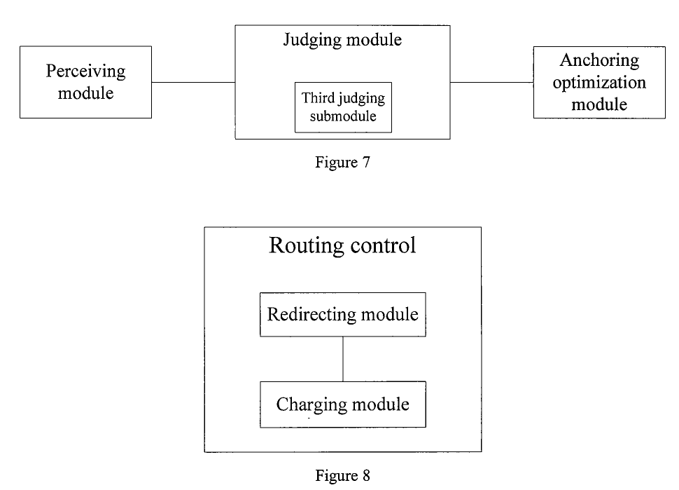

The judging module is adapted to judge whether a service potentially influential in anchoring a call can be triggered. Further, the internal structure of the judging module may vary with the type of the service information obtained by the perceiving module. As shown in FIG. 6, in scenario 1: if the service information obtained by the perceiving module is service subscription information of the user (namely, a set of services to which the user subscribes, including the services influential and non-influential in anchoring a call), the judging module includes: a first judging submodule, adapted to judge whether a service potentially influential in anchoring a call exists among the services subscribed to by the called party according to the service subscription information obtained by the perceiving module; and a second judging submodule, adapted to judge whether the service determined by the first judging submodule can be triggered. As shown in FIG. 7, in scenario 2: if the service information obtained by the perceiving module is the service processing information of the service subscribed to by the user, the judging module includes: a third judging submodule, adapted to judge whether a service potentially influential in anchoring a call can be triggered according to the service processing information of the subscribed service obtained by the perceiving module.

The anchoring optimization module is adapted to optimize the call anchoring according to the judgment result output by the judging module. According to different optimization policies, the anchoring optimization module optimizes the call anchoring in different modes. In the case that the VAO function entity works with a NeDS function entity to optimize the call anchoring, the anchoring optimization module optimizes the call anchoring by releasing the anchored VCC resources. In the case that the VAO function entity works with a Service Control Point (SCP) to optimize the call anchoring, the anchoring optimization module optimizes the call anchoring by refusing anchoring or by releasing the anchored VCC resources. In the case that the VAO function entity works with an SRF entity to optimize the call anchoring, the anchoring optimization module optimizes the call anchoring by releasing the anchored VCC resources, or releasing the anchored VCC resources and occupied call resources, or refusing anchoring. The NeDS function entity, the SCP function entity and the SRF entity are included in the VCC function entity. The NeDS function entity is adapted to select a routing domain for the incoming call; the SCP function entity is adapted to receive the anchoring request of the CS domain and return an IMRN for the call; and the SRF entity is adapted to intercept and handle the interaction messages between the GMSC and the HSS.

(II) The routing control entity in this embodiment may be, but not limited to: MGCF, Application Server (AS) or GMSC. As shown in FIG. 8, the routing control entity includes a redirecting module and a charging module that are interconnected.

The redirecting module is adapted to reroute a call according to a received redirection message.

The charging module is adapted to perform charging for the redirection service.

(III) The first interface and the second interface support different types of signaling in view of different optimization policies. When the VAO function entity works with the NeDS function entity to perform optimization, the first interface supports interaction based on SIP signaling or MAP signaling, and the second interface supports interaction based on MAP signaling or Sh interface signaling. When the VAO function entity works with the SCP function entity to perform optimization, the first interface supports interaction based on CAP signaling, and the second interface supports interaction based on MAP signaling or Sh interface signaling. When the VAO function entity works with the SRF entity to perform optimization, the first interface supports interaction based on MAP signaling or SIP signaling, and the second interface supports interaction based on MAP signaling.

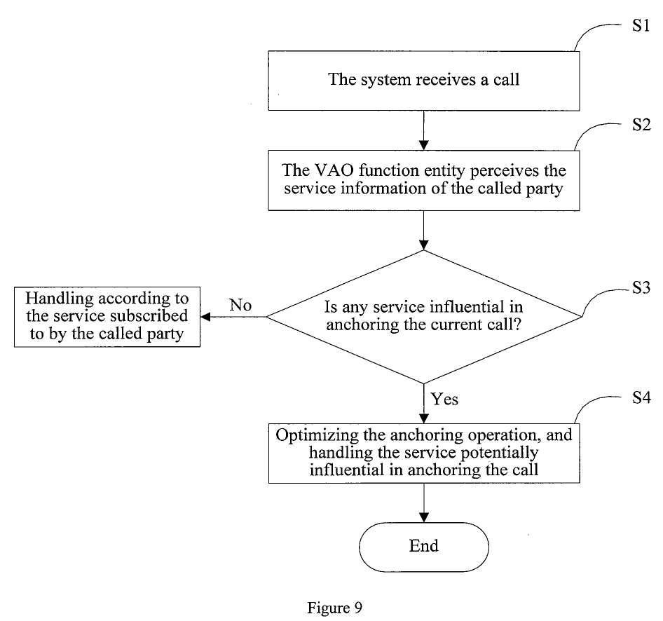

As shown in FIG. 9, a method for optimizing call anchoring in VCC provided in an embodiment of the present invention includes the following steps:

S1: The system receives a call.

The CCCF/NeDS (namely, VCC function entity) in the system receives or intercepts a call originated to the system.

S2: The VAO function entity perceives the service information of the called party.

According to different optimization policies, the VAO function entity perceives the service information of the called party in three scenarios:

Scenario 1: In the case that the VAO function entity works with a NeDS function entity of the IMS domain to optimize the call anchoring, the VAO function entity perceives the service information of the called party in one of the following four modes.

Mode 11: The VAO function entity perceives the service subscription information of the user by interacting with the HSS through the Any Time Subscription Interrogation (ATSI) operation of the MAP signaling;

Mode 12: The VAO function entity perceives, by interacting with the HSS through the route query operation of the MAP signaling, the service processing information of the service to which the user subscribes;

Mode 13: The VAO function entity perceives the service subscription information of the user by subscribing to the subscription information of the user through a MAP interface; and

Mode 14: The VAO function entity perceives the service subscription information of the user by subscribing to the subscription information of the user through an Sh interface.

Scenario 2: In the case that the VAO function entity works with an SCP to optimize the call anchoring, the VAO function entity perceives the service information of the called party in one of the following four modes:

Mode 21: The VAO function entity perceives the service subscription information of the user by interacting with the HSS through the ATSI operation of the MAP signaling;

Mode 22: The VAO function entity perceives, by interacting with the HSS through the route query operation of the MAP signaling, the service processing information of the service to which the user subscribes;

Mode 23: The VAO function entity perceives the service subscription information of the user by subscribing to the subscription information of the user through a MAP interface;

Mode 24: The GMSC puts the service information of the user into the message sent to the VAO function entity so that the VAO function entity perceives the service processing information of the service subscribed to by the user.

Scenario 3: In the case that the VAO function entity works with an SRF entity to optimize the call anchoring, the VAO function entity perceives the service information of the called party in one of the following three modes:

Mode 31: The VAO function entity perceives the service subscription information of the user by interacting with the HSS through the ATSI operation of the MAP signaling;

Mode 32: The VAO function entity perceives, by interacting with the HSS through the route query operation of the MAP signaling, the service processing information of the service to which the user subscribes; and

Mode 33: The VAO function entity perceives the service subscription information of the user by subscribing to the subscription information of the user through a MAP interface.

S3: The VAO function entity judges whether a service potentially influential in anchoring the current call exists; if a service potentially influential in anchoring the current call exists, the process proceeds to step S4; otherwise, the process is the same as that of a service subscribed to by the called party.

In step S2, if the service information perceived by the VAO function entity is the service subscription information of the user, the VAO function entity checks the service information of the called party to judge whether a service potentially influential in anchoring a call exists. If such a service exists, the VAO function entity judges whether the service potentially influential in anchoring a call can be triggered. If it can be triggered, the process proceeds to step S4.

In step S2, if the service information perceived by the VAO function entity is the service processing information of the service subscribed to by the user and the VAO function entity determines that a service potentially influential in anchoring a call can be triggered, the process proceeds to step S4.

S4: The call anchoring is optimized, and the service potentially influential in anchoring a call is handled.

In view of the three scenarios of perceiving the service information of the called party mentioned in step S2, the VAO function entity optimizes the call anchoring in the following three scenarios:

Scenario 1: In the case that the VAO function entity works with a NeDS function entity of the IMS domain to optimize the call anchoring, the VAO function entity sends a redirection message to the routing control entity (which is an MGCF, AS or GMSC), so that the routing control entity handles the service potentially influential in anchoring a call and releases the anchored VCC resources. Upon completion of redirection, the MGCF, AS or GMSC may perform charging for the redirection service.

Further, in step S2, if the VAO function entity uses mode 11, mode 13 or mode 14 to perceive the service information, the VAO function entity sends a redirection message to the MGCF or the AS that serves the user to release the anchored VCC resources.

Further, in step S2, if the VAO function entity uses mode 12 to perceive the service information and the call passes through the GMSC before being anchored, the VAO function entity sends a redirection message to the GMSC to release the anchored VCC resources.

Further, in step S2, if the VAO function entity uses mode 12 to perceive the service information and the call does not pass through the GMSC before being anchored, the VAO function entity sends a redirection message to the MGCF or the AS that serves the user to release the anchored VCC resources.

Scenario 2: In the case that the VAO function entity works with a Service Control Point (SCP) to optimize the call anchoring, the VAO function entity optimizes the call anchoring by refusing anchoring or by releasing the anchored VCC resources.

Further, if the VAO function entity optimizes the call anchoring by refusing anchoring and the VAO function entity in step S2 perceives the service information in mode 21, mode 22, mode 23 or mode 24, the VAO function entity sends a CAMEL message carrying VCC information to the routing control entity (namely, GMSC), so that the routing control entity could handle the service.

Further, if the VAO function entity optimizes the call anchoring by releasing the anchored VCC resources, and the VAO function entity in step S2 uses mode 22 to perceive the service information, and the call does not pass through the GMSC before being anchored, the VAO function entity sends a redirection message to the MGCF or the AS that serves the user to release the anchored VCC resources. Upon completion of redirection, the MGCF or the AS may perform charging for the redirection service.

Further, if the VAO function entity optimizes the call anchoring by releasing the anchored VCC resources, and the VAO function entity in step S2 uses mode 22 to perceive the service information, and the call does not pass through the GMSC before being anchored, the VAO function entity sends a redirection message to the GMSC to release the anchored VCC resources. Upon completion of redirection, the GMSC may perform charging for the redirection service.

Scenario 3: In the case that the VAO function entity works with an SRF entity to optimize the call anchoring, the VAO function entity optimizes the call anchoring by refusing anchoring, releasing the anchored VCC resources, or releasing the anchored VCC resources and occupied call resources.

Further, if the VAO function entity optimizes the call anchoring by refusing anchoring, and the VAO function entity in step S2 perceives the service information in mode 31 or mode 33, and the call passes through the GMSC (a routing control entity) before being anchored, the VAO function entity sends an SRI message (namely, MAP message) carrying the call forwarding information to the GMSC, so that the routing control entity could handle the service without anchoring the call.

Further, if the VAO function entity optimizes the call anchoring by releasing the anchored VCC resources, and the VAO function entity in step S2 uses mode 31 or mode 33 to perceive the service information, and the call does not pass through the GMSC before being anchored, the VAO function entity sends a redirection message to the MGCF or the AS that serves the user to release the anchored VCC resources. Upon completion of redirection, the MGCF or the AS may perform charging for the redirection service.

Further, if the VAO function entity optimizes the call anchoring by releasing the anchored VCC resources and occupied call resources (allocated by the GMSC that is initially passed through by the call after domain selection for the purpose of call routing), and the VAO function entity in step S2 uses mode 32 to perceive the service information, and the call passes through the GMSC before being anchored, the VAO function entity sends a redirection message to the GMSC to release the anchored VCC resources and occupied call resources. Upon completion of redirection, the GMSC may perform charging for the redirection service.

Further, if the VAO function entity optimizes the call anchoring by releasing the anchored VCC resources and occupied call resources (allocated by the GMSC that is initially passed through by the call after domain selection for the purpose of call routing), and the VAO function entity in step S2 uses mode 32 to perceive the service information, and the call passes through the GMSC before being anchored, the VAO function entity sends a redirection message to the GMSC or the AS that serves the user to release the anchored VCC resources and occupied call resources. Upon completion of redirection, the GMSC may perform charging for the redirection service.

In this step, the call may be anchored before, when or after the service potentially influential in anchoring the call is performed.

In view of the early forwarding service, the present invention is described below through ten embodiments.

### Embodiment 1

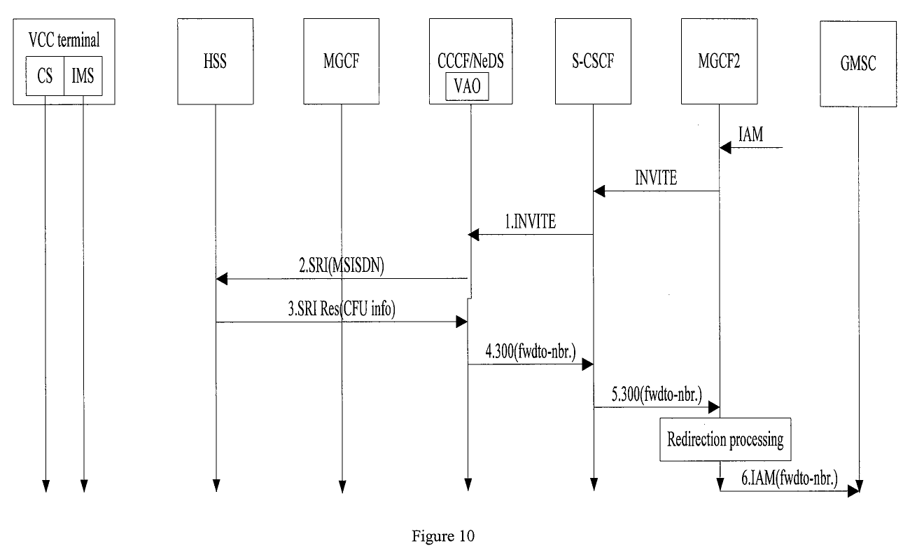

The VAO works with the NeDS of the IMS network to optimize the call anchoring, in which the service information is perceived through interaction of an SRI message. Here the forwarded to number is exemplified by a mobile number, but the practical application is not limited to mobile numbers; the message interaction for perceiving service information is exemplified by 3GPP messages, but the actual application is not limited to 3GPP messages, and the service information may be perceived through interaction of 3GPP2 messages such as a location query message. As shown in FIG. 10, the process includes the following steps:

1. The CCCF/NeDS receives an INVITE message of an incoming call.

2. The CCCF/NeDS obtains routing information of the CS domain from the HSS of the user.

3. The VCC user subscribes to the CFU service of the CS domain, and returns an SRI Ack message which carries the forwarded-to number.

4. If the VAO determines that the call enters the IMS network from an MGCF entity according to the VIA header field in the received INVITE message, the VAO returns a SIP 300 message to the S-CSCF of the user, indicating to redirect the call (this step may be different in different scenarios). Afterward, the anchored resources are released.

5. The S-CSCF sends a SIP 300 message to the MGCF2, indicating to redirect the call.

6. After receiving the redirection message, the MGCF2 analyzes the forwarded-to number, and routes the call to the GMSC of the forwarded-to number for further processing. The call forwarding of the VCC user is reflected in the charging information.

### Embodiment 2

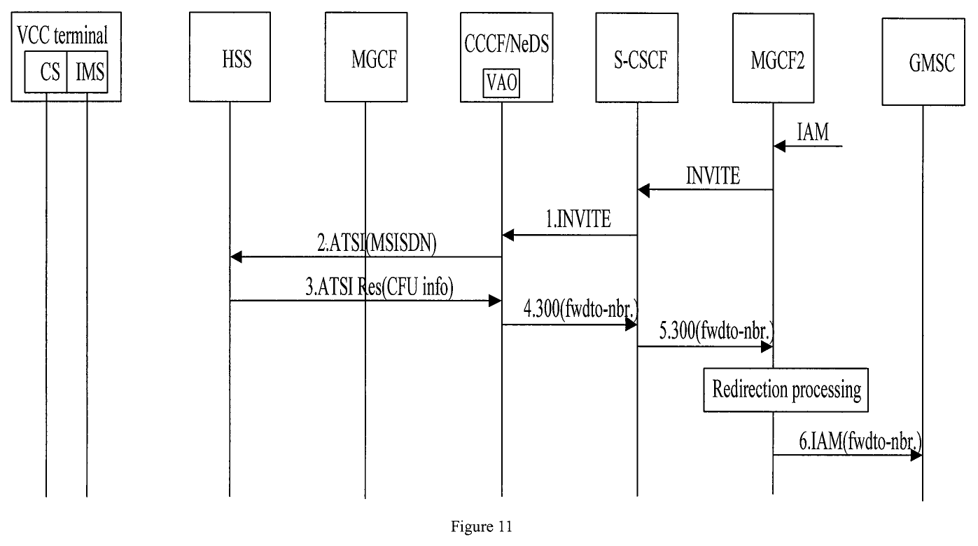

The VAO works with the NeDS of the IMS network to optimize the call anchoring, in which the service information is perceived through Any Time Subscription Interrogation (ATSI). Here the forwarded-to number is exemplified by a mobile number, but the practical application is not limited to mobile numbers; the subscription information is perceived through ATSI, but the practical application is not limited to ATSI; the message interaction is exemplified by 3GPP messages, but the actual application is not limited to 3GPP messages, and the subscription information may be perceived through 3GPP2 message interaction or other nonstandard interaction mode, or through the technologies mentioned in the fifth embodiment. As shown in FIG. 11, the process includes the following steps:

1. The CCCF/NeDS receives an INVITE message of an incoming call.

2. The CCCF/NeDS obtains the roaming number of the CS domain from the HSS of the user.

3. The VCC user subscribes to the CFU service of the CS domain, and returns an SRI Ack message which carries the forwarded-to number.

4. If the VAO determines that the call enters the IMS network from an MGCF entity according to the VIA header field in the received INVITE message, the VAO returns a SIP 300 message to the S-CSCF of the user, indicating to redirect the call. Afterward, the anchored resources are released.

5. The S-CSCF sends a SIP 300 message to the MGCF2, indicating to redirect the call.

6. After receiving the redirection message, the MGCF analyzes the forwarded-to number, and routes the call to the GMSC of the forwarded-to number for further processing. The call forwarding of the VCC user is reflected in the charging information.

### Embodiment 3

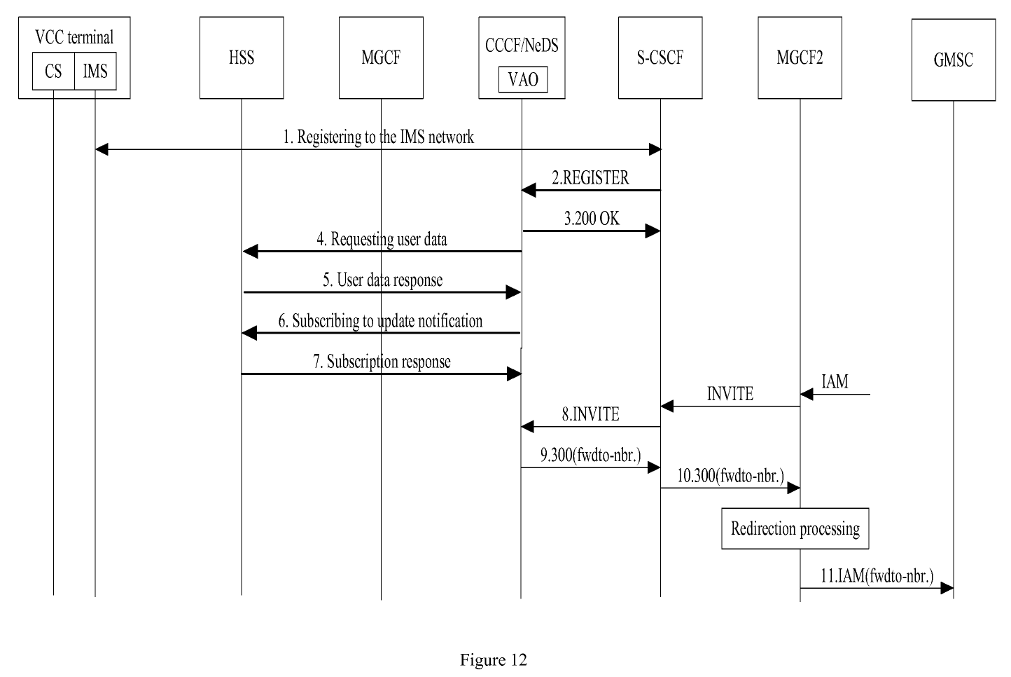

The VAO works with the NeDS of the IMS network to optimize the call anchoring, in which an Sh interface is used to subscribe to the subscription information so that the subscription information is perceived. Here the forwarded-to number is exemplified by a mobile number, but the practical application is not limited to mobile numbers; the subscription information is perceived by means of IMS third-party registration, but the actual application is not limited to the IMS third-party registration mode. As shown in FIG. 12, the process includes the following steps:

1. The VCC user is registered to the IMS network.

2-7. The S-CSCF initiates a third-party registration to the NeDS. The NeDS downloads user subscription information from the HSS, and subscribes to the subscription information change notification to obtain the latest service information of the user.

8. The CCCF/NeDS receives an INVITE message of an incoming call.

9. If the VAO knows that the CFU service subscribed to by the user can be triggered according to the subscription information and determines that the call enters the IMS network from an MGCF2 entity according to the VIA header field in the received INVITE message, the VAO returns a SIP 300 message to the S-CSCF of the user, indicating to redirect the call. Afterward, the anchored resources are released.

10. The S-CSCF sends a SIP 300 message to the MGCF2, indicating to redirect the call.

11. After receiving the redirection message, the MGCF analyzes the forwarded-to number, and routes the call to the GMSC of the forwarded-to number for further processing. The call forwarding of the VCC user is reflected in the charging information.

### Embodiment 4

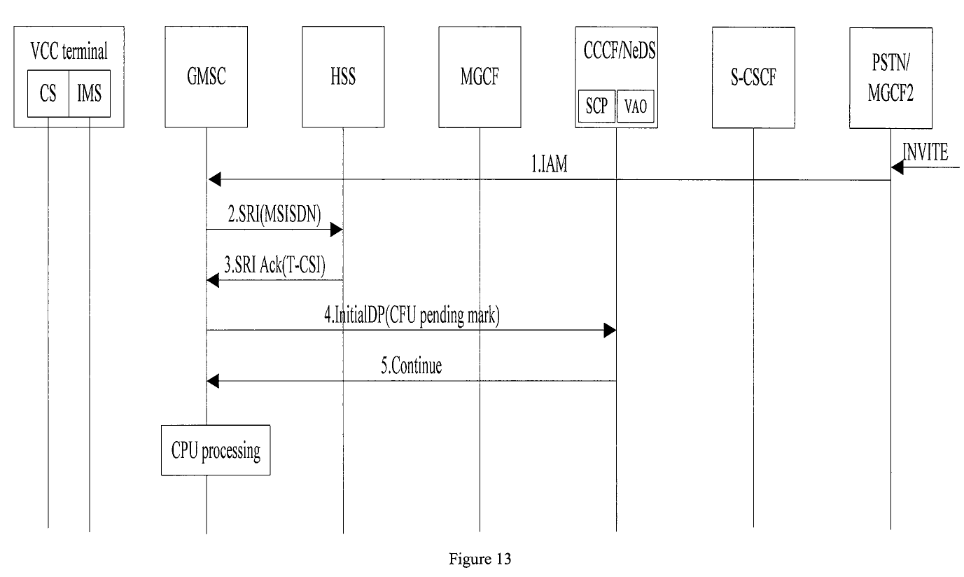

The VAO works with the SCP to optimize the call anchoring, and the service information is perceived through the CAMEL technology, for example, through 3GPP message interaction. However, the practical application is not limited to the 3GPP message interaction mode, and the service information may also be perceived through 3GPP2 message interaction, or through the technologies applied in embodiments 1, 2 and 6. As shown in FIG. 13, the process includes the following steps:

1-3. After a CS domain call arrives at the GMSC, the GMSC sends an SRI message to the HSS to obtain the roaming information of the user. The HSS returns T-CSI and CFU information according to the subscription information of the user.

4. The GMSC invokes the CAMEL service to trigger the call to the NeDS for further processing. Because the user has subscribed to the CFU service, this information is included in the triggering message.

5. After the CCCF/NeDS receives the information, the VAO detects that the user can trigger the early forwarding service, and returns a Continue message to instruct the GMSC to continue processing the CFU service.

In this way, the CFU service can be processed completely at the GMSC, with no IMRN being allocated by the IMS network for call anchoring, thus avoiding ineffective anchoring.

### Embodiment 5

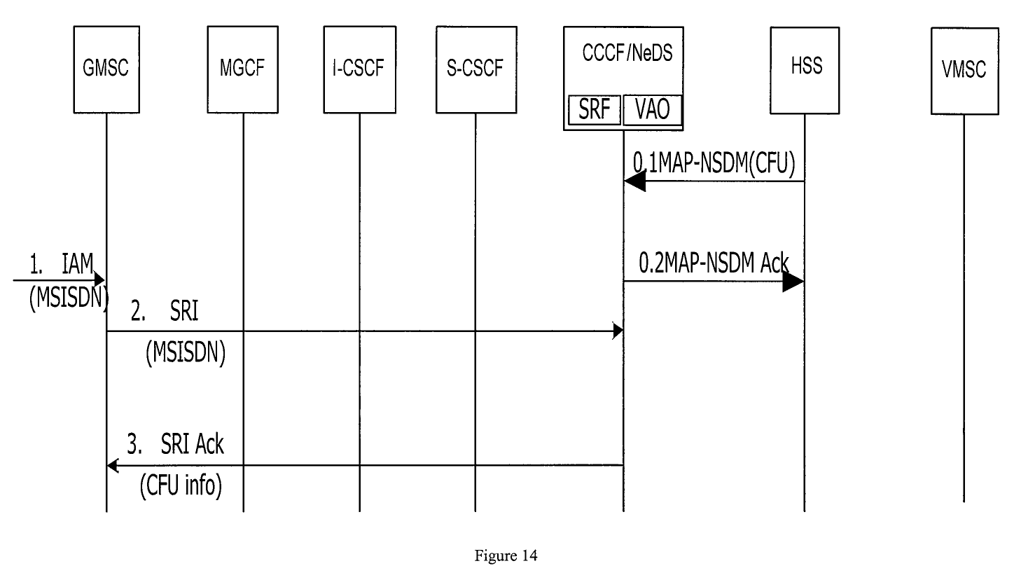

The VAO works with the VCC-SRF to optimize the call anchoring, and the service information is perceived through the active notification from the HSS, for example, through 3GPP message interaction. However, the practical application is not limited to 3GPP message interaction, and the service information may also be perceived through 3GPP2 message interaction or other interaction modes, or through the technologies applied in embodiments 1 and 2. As shown in FIG. 14, the process includes the following steps:

0.1-0.2. The VAO uses the MAP-NOTE-SUBSCRIBER-DATA-MODIFIED service to subscribe to the call forwarding service data change notification of the user from the HSS. The HSS notifies the VAO once the call forwarding service data changes, and the VAO saves the changed information.

1-3. The VCC-SRF intercepts the SRI message sent by the GMSC to the HSS. If the VCC-SRF detects that the user can trigger the early forwarding service according to the saved call forwarding service data, the VCC-SRF decides to return the call forwarding information to instruct the GMSC to handle the call forwarding service. The GMSC handles the CFU based on the prior art.

### Embodiment 6

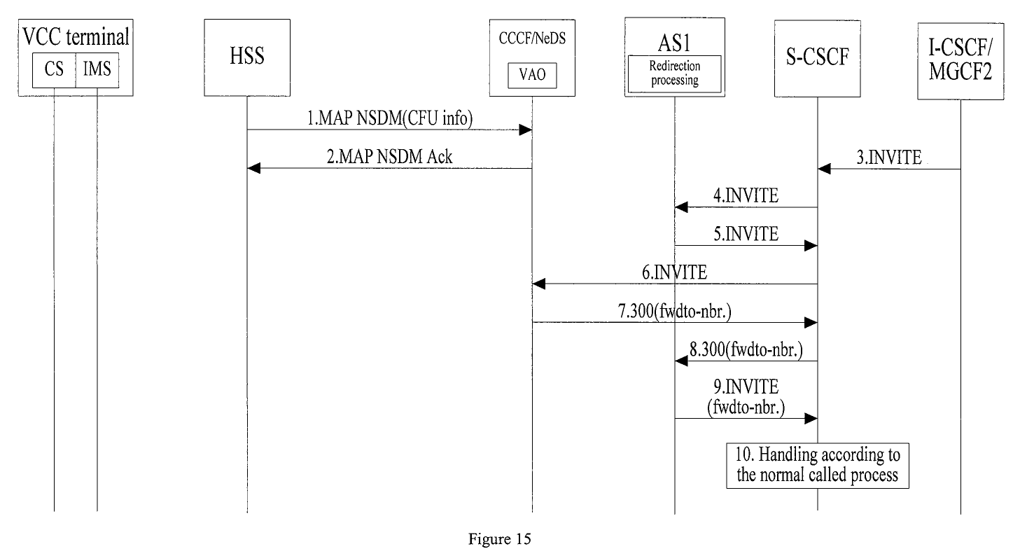

The VAO works with the NeDS of the IMS network to optimize the call anchoring, in which the AS handles the call forwarding service and the service information is perceived through active notification from the HSS, for example, the HSS sends a notification actively through 3GPP message interaction. However, the practical application is not limited to 3GPP message interaction, and the service information may also be perceived through interaction of 3GPP2 messages such as location query messages, or through the technologies applied in embodiments 1, 2 and 3. As shown in FIG. 15, the process includes the following steps:

1-2. The VAO uses the MAP-NOTE-SUBSCRIBER-DATA-MODIFIED service to subscribe to the call forwarding service data change notification of the user from the HSS. The HSS notifies the VAO once the call forwarding service data changes, and the VAO saves the changed information.

3-4. After receiving an INVITE request, the S-CSCF triggers the call to the ASI for further processing according to the initial filtering condition (iFC) of the user.

5. The ASI is capable of handling redirection messages. After finishing other service processing for the user, the ASI routes the call back to the S-CSCF for further processing.

6. According to the triggering condition, the S-CSCF triggers the call to the CCCF/NeDS for further processing.

7. The VAO detects that the user can trigger the early forwarding service according to the saved call forwarding service data, and hence sends a SIP 300 message to the S-CSCF.

8. The S-CSCF sends a redirection message to the ASI according to the path of triggering call processing.

9. After receiving the redirection message, the ASI handles the message, and at least generates a record of expenses arising from redirection; the AS1 sends an INVITE message to the S-CSCF, instructing to continue routing the call.

10. The S-CSCF handles the call according to the normal IMS process.

### Embodiment 7

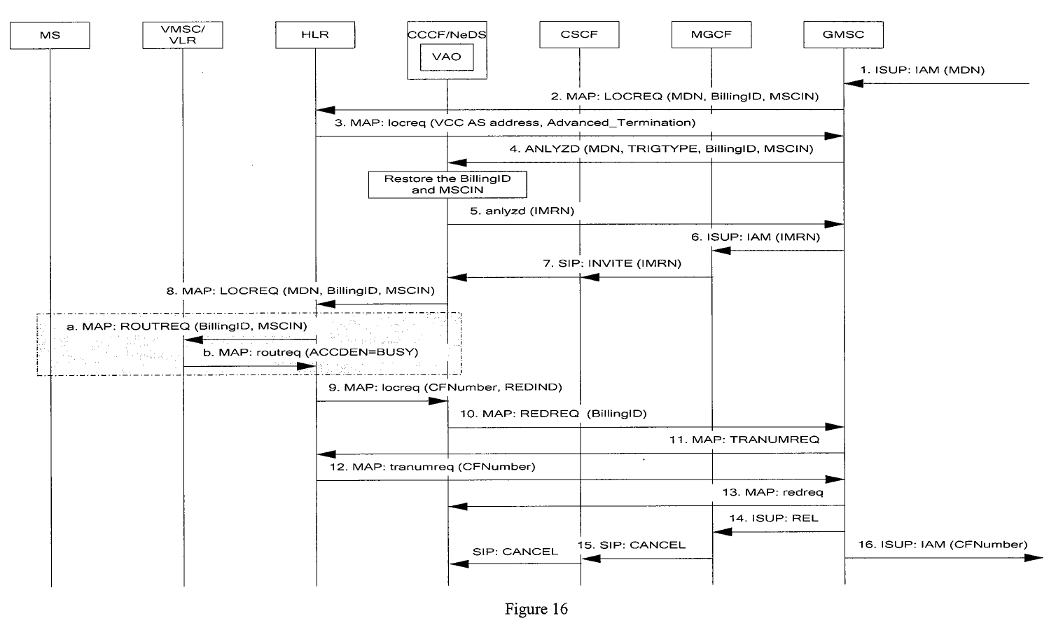

The VAO works with the NeDS to optimize the call anchoring, in which the message interaction for perceiving service information is exemplified by 3GPP2 messages, but the actual application is not limited to 3GPP2 messages, and the service information may be perceived through interaction of 3GPP messages such as an SRI message. This mode of perceiving service information is also applicable to the process of a VAO working with an SCP. The call is received from the CS domain and routed to the IMS domain for anchoring. As shown in FIG. 16, the process includes the following steps:

1. The GMSC receives a call request from the CS domain.

2. The GMSC requests intelligent data from the HLR.

3. The HLR returns the intelligent trigger data subscribed to by the user.

4. The GMSC triggers the intelligent control signaling “ANLYZD” to the VCC AS according to the trigger data of the user, in which the signaling carries the address of the GMSC and the allocated BillingID parameter.

5. If the VCC AS determines that the call needs to be routed to the IMS domain for anchoring, the VCC AS saves the GMSC address and the BillingID parameter, allocates an IMS domain routing number “IMRN” and returns it to the GMSC.

6. According to the IMRN, the GMSC routes the call to the MGCF at the ingress of the IMS domain.

7. The MGCF sends a SIP session request to the VCC AS through a Call Session Control Function (CSCF) of the IMS domain.

8. If the VCC AS determines that the call needs to be routed to the called party in the CS domain, the VCC AS requests a user roaming number from the HLR.

9. The HLR returns a call forwarding indication “REDIND” and a forwarded-to number “CFNumber” to the VCC AS if: (i) the HLR determines that the User Equipment (UE) is powered off and the user has subscribed to the CFNR service, or the VMSCNVLR sends back a busy state of the user when the HLR requests a roaming number from the VMSC/VLR (as described in step a and step b); and (ii) the user has subscribed to the CFB service.

10. According to the saved GMSC address, the VCC AS sends a REDREQ message to the GMSC to notify the GMSC to perform call forwarding, in which the message carries the cause “REDIND” and the BillingID parameter that is allocated by the GMSC and saved previously.

11. After receiving the REDREQ message, the GMSC correlates the previous session records according to the BillingID parameter carried in the message, and then sends a TRANUMREQ message to the HLR to request a forwarded-to number, with the cause of call forwarding carried in the message.

12. The HLR returns the forwarded-to number subscribed to by the user according to the cause of call forwarding.

13. The GMSC returns a response message about call redirection to the VCC AS.

14. The GMSC sends a call release signaling to the MGCF, and releases the call route directed to the IMS domain.

15. The MGCF sends a SIP session release message to the CSCF and the VCC AS to release the SIP session.

16. The GMSC originates a new call to the forwarded-to number by using the forwarded-to number.

### Embodiment 8

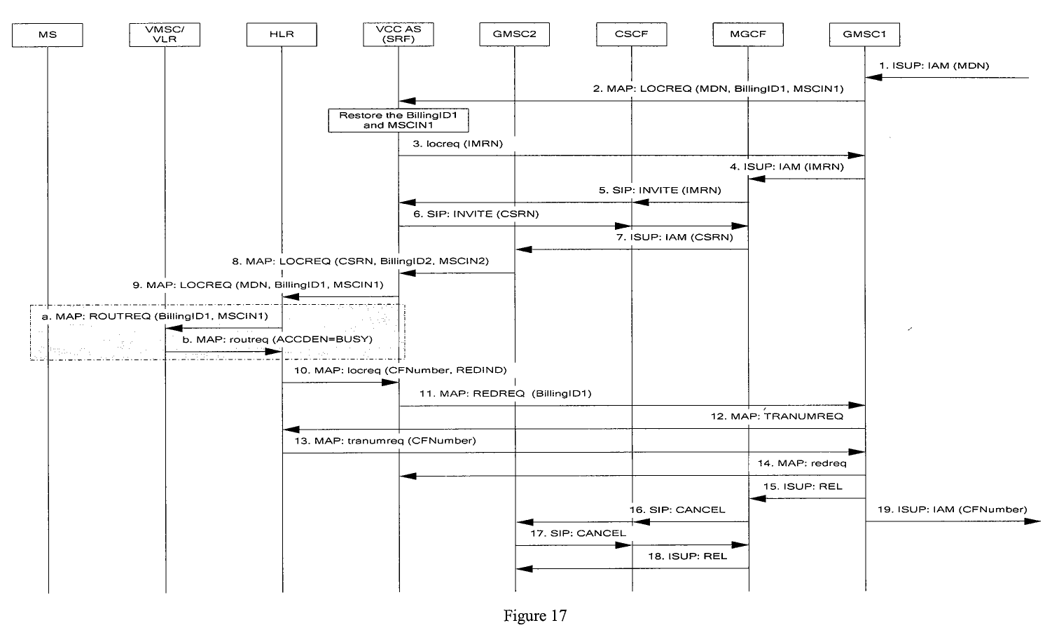

The VAO works with the SRF, and the call is received from the CS domain and routed to the IMS domain for anchoring. As shown in FIG. 17, the process includes the following steps:

1. The GMSC1 receives a call request from the CS domain.

2. The GMSC1 sends a message to the HLR to query for the called party data. The query message carries the address of the GMSC1 and the allocated BillingID parameter, and is intercepted by the VCC AS that works as an SRF.

3. If the VCC AS determines that the call needs to be routed to the IMS domain for anchoring, the VCC AS saves the original called number “MDN”, the GMSC1 address and the BillingID parameter, allocates an IMS domain routing number “IMRN” and returns it to the GMSC1.

4. According to the IMRN, the GMSC1 routes the call to the MGCF at the ingress of the IMS domain.

5. The MGCF sends a SIP session request to the VCC AS through a Call Session Control Function (CSCF) of the IMS domain.

6. If the VCC AS determines that the call needs to be routed to the called party in the CS domain, the VCC AS initiates a new SIP session, using the CS domain routing number “CSRN” as a called party ID. The session is routed to the MGCF through a CSCF.

7. After receiving the session with CSRN as a called party ID, the MGCF initiates a call, using the CSRN as a called number. The call is routed to the GMSC2. It is possible that the GMSC2 and GMSC1 are the same entity physically, but are different call processing entities logically.

8. The GMSC2 queries the HLR for the called party location, using the CSRN as a called number. The message carries the address of the GMSC2 and the allocated BillingID parameter. The message is intercepted by the VCC AS that works as an SRF.

9. The VCC AS queries the HLR for the called party location by using the original called number “MDN”. The message carries the saved GMSC1 address and the BillingID parameter allocated by the GMSC1.

10. The HLR returns a call forwarding indication “REDIND” and a forwarded-to number “CFNumber” to the VCC AS if: (i) the HLR determines that the UE is powered off and the user has subscribed to the CFNR service, or the VMSC/VLR sends back a busy state of the user when the HLR requests a roaming number from the VMSCNVLR (as described in step a and step b); and (ii) the user has subscribed to the CFB service.

11. After determining that the HLR returns a call forwarding indication, the VCC AS sends a REDREQ message to the GMSC1 to notify the GMSC1 to perform call forwarding according to the saved GMSC1 address, in which the message carries the cause “REDIND” and the BillingID parameter that is allocated by the GMSC1 and saved previously.

12. After receiving the REDREQ message, the GMSC1 correlates the previous session records according to the BillingID parameter carried in the message, and then sends a TRANUMREQ message to the HLR to request a forwarded-to number, with the cause of call forwarding carried in the message.

13. The HLR returns the forwarded-to number subscribed to by the user according to the cause of call forwarding.

14. The GMSC1 returns a response message about call redirection to the VCC AS.

15. The GMSC1 sends a call release message to the MGCF, and releases the call route directed to the IMS domain.

16. The MGCF sends a SIP session release message to the CSCF and the VCC AS to release the SIP session set up in step 5.

17. After receiving the session release message, the VCC AS sends a session release message to the CSCF and the MGCF to release the session set up in step 6.

18. After receiving the session release message, the MGCF sends a call release message to the GMSC2 to release the call set up in step 7.

19. The GMSC1 originates a new call to the forwarded-to number by using the forwarded-to number.

### Embodiment 9

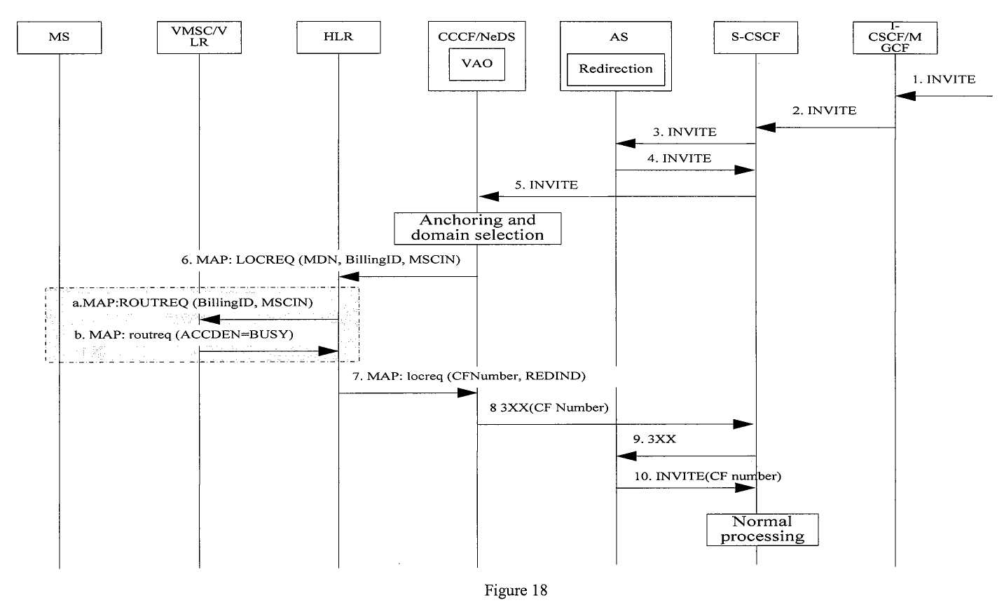

The VAO works with the NeDS to optimize the call anchoring, in which the message interaction for perceiving service information is exemplified by 3GPP2 messages, but the actual application is not limited to 3GPP2 messages, and the service information may be perceived through interaction of 3GPP messages such as an SRI message. This mode of perceiving service information is also applicable to the process of a VAO working with an SCP. The call is received from the IMS domain for anchoring. As shown in FIG. 18, the process includes the following steps:

1. The I-CSCF or the MGCF receives a call request.

2. The call is routed to the S-CSCF of the user.

3. According to the iFC, the S-CSCF triggers the call to the AS of the redirection service.

4. After processing the call, the AS instructs the S-CSCF to continue to process the call.

5. According to the triggering rules, the S-CSCF triggers the call to the VCC AS for further processing.

6. If the VCC AS completes anchoring and decides to route the call to the called party in the CS domain, the VCC AS requests a user roaming number from the HLR.

7. The HLR returns a call forwarding indication “REDIND” and a forwarded-to number “CFNumber” to the VCC AS if: (i) the HLR determines that the UE is powered off and the user has subscribed to the CFNR service, or the VMSC/VLR sends back a busy state of the user when the HLR requests a roaming number from the VMSC/VLR (as described in step a and step b); and (ii) the user has subscribed to the CFB service.

8. According to the received call forwarding information, the VCC AS generates a SIP redirection message and sends it to the S-CSCF for processing, and releases the anchored VCC resources.

9. The S-CSCF sends the redirection request along the path to the AS for further processing.

10. The AS invokes the redirection processing function to process the call according to the received call forwarding information; afterward, the S-CSCF handles the call according to the normal call process.

### Embodiment 10

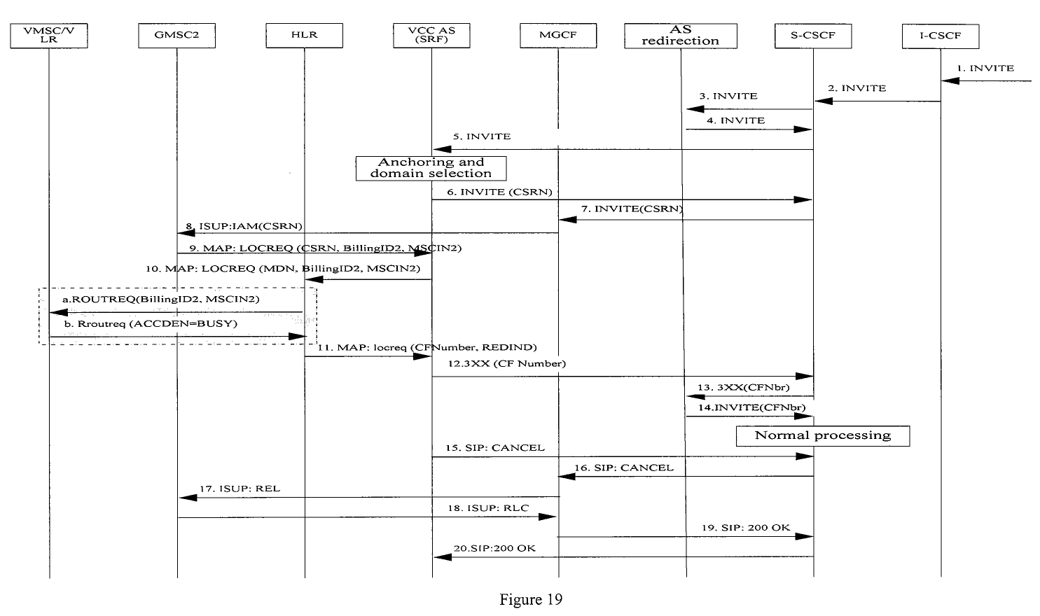

The VAO works with the SRF, and the call is received from the IMS domain for anchoring. As shown in FIG. 19, the process includes the following steps:

1. The I-CSCF or the MGCF receives a session request.

2. The session is routed to the S-CSCF of the user.

3. According to the iFC, the S-CSCF triggers the call to the AS of the redirection service.

4. After processing the call, the AS instructs the S-CSCF to continue to process the session.

5. According to the triggering rules, the S-CSCF triggers the session to the VCC AS for further processing.

6. After anchoring the call and determining that the call needs to be routed to the called party in the CS domain, the VCC AS initiates a new SIP session, using the CS domain routing number “CSRN” as a called party ID. The session is sent to the S-CSCF for processing.

7. The S-CSCF routes the session to the MGCF according to the CSRN.

8. After receiving the session with CSRN as a called party ID, the MGCF initiates a call, using the CSRN as a called number. The call is routed to the GMSC2.

9. The GMSC2 queries the HLR for the called party location, using the CSRN as a called number. The message carries the address of the GMSC2 and the allocated BillingID parameter. The message is intercepted by the VCC AS that works as an SRF.

10. The VCC AS queries the HLR for the called party location by using the original called number “MDN”. The message carries the received GMSC2 address and the BillingID parameter allocated by the GMSC2.

11. The HLR returns a call forwarding indication “REDIND” and a forwarded-to number “CFNumber” to the VCC AS if: (i) the HLR determines that the UE is powered off and the user has subscribed to the CFNR service, or the VMSCNVLR sends back a busy state of the user when the HLR requests a roaming number from the VMSC/VLR (as described in step a and step b); and (ii) the user has subscribed to the CFB service.

12. After determining that the HLR returns a call forwarding indication, the VCC AS generates a SIP redirection message according to the received call forwarding information and sends the message to the S-CSCF for processing, and releases the anchored VCC resources.

13-14. The S-CSCF sends the redirection request along the path to the AS for processing, and the AS invokes the redirection processing function to process the call according to the received call forwarding information; afterward, the S-CSCF handles the call according to the normal call process.

15. The S-CSCF sends a CANCEL message backward to release the call resources for routing in the CS domain.

16-20. The subsequent call resources used for CS routing are released.

It should be noted that the CANCEL message in step 15 may also be sent before a redirection message is sent to the S-CSCF in step 12.

In conclusion, the VAO function entity provided in embodiments of the present invention perceives the service information of the called party; and optimizes the call anchoring when determining that the service subscribed to by the called party may affect anchoring of the current call.

Further, the embodiments of the present invention provide different anchoring optimization modes for different service types. In the case that the VAO function entity works with an NeDS function entity of the IMS domain to optimize the call anchoring, the VAO function entity optimizes the call anchoring by releasing the anchored VCC resources; in the case that the VAO function entity works with a Service Control Point (SCP) to optimize the call anchoring, the VAO function entity optimizes the call anchoring by refusing anchoring or releasing the anchored VCC resources. In the case that the VAO function entity works with an SRF entity to optimize the call anchoring, the VAO function entity optimizes the call anchoring by releasing the anchored VCC resources and/or other call resources or refusing anchoring.

Further, considering the services that are influential in anchoring a call (such as early forwarding service), the embodiments of the present invention use an MGCF or AS or GMSC to redirect calls while optimizing the call anchoring, thus achieving a better implementation effect. Upon completion of redirection, the MGCF, AS or GMSC may perform charging for the redirection service to bring revenues for the operator.

To support the foregoing method, the embodiments of the present invention also provide a system for optimizing call anchoring in VCC, a VCC anchoring optimization function entity, and a routing control entity.

Although the invention has been described through some exemplary embodiments, the invention is not limited to such embodiments. It is apparent that those skilled in the art can make various modifications and variations to the present invention without departing from the spirit and scope of the present invention. The present invention is intended to cover these modifications and variations provided that they fall in the scope of protection defined by the following claims or their equivalents.

What is claimed is:

1. A method for optimizing call anchoring in Voice Call Continuity (VCC) comprising:
optimizing call anchoring when determining that service which affects anchoring of call can be triggered according to service information of a called party.

2. The method of claim 1, wherein if the service information is service subscription information of user, the process of optimizing call anchoring when determining that the service which affects anchoring of the call can be triggered comprises:
determining whether the service information of the called party contains a service influential in anchoring the call;
determining whether the service influential in anchoring the call could be triggered, if the service information of the called party contains a service influential in anchoring the call; and
optimizing the call anchoring if the service influential in anchoring the call could be triggered.

3. The method of claim 1, wherein the call anchoring is optimized by:
terminating the anchoring for the call; or releasing anchored VCC resources; or
releasing anchored VCC resources and occupied call resources.

4. The method of claim 3, wherein the occupied call resources are the call resources that are allocated by a Gateway Mobile Switching Center (GMSC) initially passed through by the call after domain selection for the purpose of call routing.

5. The method of claim 3, wherein, the call anchoring is optimized by sending a redirection message to a routing control entity to release the anchored VCC resources or to release the anchored VCC resources and occupied call resources.

6. The method of claim 5, wherein the routing control entity is a Media Gateway Control Function (MGCF), and the method comprises:
sending a redirection message to a Serving-Call Session Control Function (S-CSCF) of the user;
by the S-CSCF, sending a redirection message to the MGCF, indicating to redirect the call; and
by the MGCF, performing route analysis for the forwarded-to number after receiving the redirection message, and forwarding the call to a corresponding routing control entity to continue routing the call accordingly.

7. The method of claim 5, wherein the routing control entity is an Application Server (AS), and the method comprises:
sending a redirection message to a Serving-Call Session Control Function (S-CSCF) of the user;
by the S-CSCF, sending the redirection message to the AS according to a path of triggering call processing; and
by the AS, sending a session initial protocol (SIP) message to the S-CSCF after receiving the redirection message, thus instructing the S-CSCF to continue routing the call.

8. The method of claim 5, wherein the routing control entity is a Gateway Mobile Switching Center (GMSC) that the call passes through before being anchored, and the method comprises:
sending a redirection message to the GMSC of the user; and
by the GMSC, continuing to route the call according to the received redirection information.

9. The method of claim 3, wherein if the call anchoring is optimized by terminating the anchoring for the call, the method further comprises:
sending a CAMEL message to a routing control entity, with a processing information carried in the message, thereby the routing control entity can process the service.

10. The method of claim 3, wherein if the call anchoring is optimized by terminating the anchoring for the call, the method further comprises:
sending a MAP message to a routing control entity, with a call forwarding information carried in the message, thereby the routing control entity can process the service.

11. The method of claim 1, wherein, a VCC Anchoring Optimization (VAO) function entity perceives the service information of the called party in one of the following four modes in the case that the VAO function entity works with a Network Domain Selection (NeDS) function entity of the IP Multimedia Subsystem (IMS) domain to optimize the call anchoring:
Mode 11: perceiving the service subscription information of the user by interacting with a Home Subscriber Server (HSS) through an Any Time Subscription Interrogation (ATSI) operation of the MAP signaling;
Mode 12: perceiving the service processing information of the service subscribed to by the user by interacting with the HSS through the route query operation of the MAP signaling;
Mode 13: perceiving the service subscription information of the user by subscribing to the subscription information of the user through a MAP interface; and
Mode 14: perceiving the service subscription information of the user by subscribing to the subscription information of the user through an Sh interface.

12. The method of claim 11, wherein, if the VAO function entity uses mode 11, mode 13 or mode 14 to perceive the service information, the VAO function entity sends a redirection message to a Media Gateway Control Function (MGCF) or an Application Server (AS) that serves the user to release the anchored VCC resources.

13. The method of claim 11, wherein, if the VAO function entity uses mode 12 to perceive the service information and the call passes through the GMSC before being anchored, the VAO function entity sends a redirection message to the GMSC to release the anchored VCC resources.

14. The method of claim 11, wherein, if the VAO function entity uses mode 12 to perceive the service information and the call does not pass through the GMSC before being anchored, the VAO function entity sends a redirection message to a Media Gateway Control Function (MGCF) or an Application Server (AS) that serves the user to release the anchored VCC resources.

15. The method of claim 3, wherein, a VCC Anchoring Optimization (VAO) function entity perceives the service information of the called party in one of the following four modes in the case that the VAO function entity works with a Service Control Point (SCP) to optimize the call anchoring:
Mode 21: perceiving the service subscription information of the user by interacting with a Home Subscriber Server (HSS) through an Any Time Subscription Interrogation (ATSI) operation of the MAP signaling;
Mode 22: perceiving the service processing information of the service subscribed to by the user by interacting with the HSS through the route query operation of the MAP signaling;
Mode 23: perceiving the service subscription information of the user by subscribing to the subscription information of the user through a MAP interface; and
Mode 24: by the GMSC, putting the service information of the user into a message sent to the VAO function entity thereby the VAO function entity perceives the service processing information of the service subscribed to by the user.

16. The method of claim 3, wherein, a VCC Anchoring Optimization (VAO) function entity perceives the service information of the called party in one of the following three modes in the case that the VAO function entity works with a Special Resource Function (SRF) entity to optimize the call anchoring:
Mode 31: perceiving the service subscription information of the user by interacting with the Home Subscriber Server (HSS) through the Any Time Subscription Interrogation (ATSI) operation of the MAP signaling;
Mode 32: perceiving the service processing information of the service subscribed to by the user by interacting with the HSS through the route query operation of the MAP signaling; and
Mode 33: perceiving the service subscription information of the user by subscribing to the subscription information of the user through a MAP interface.

17. A VCC Anchoring Optimization (VAO) function entity, comprising:
a perceiving module, adapted to obtain a service information of a called user;
a judging module, adapted to judge whether a service influential in anchoring a call can be triggered according to the service information; and
an anchoring optimization module, adapted to optimize the call anchoring when the service influential in anchoring the call can be triggered.

18. The entity of claim 17, wherein the judging module comprises:
a first judging submodule, adapted to judge whether a service influential in anchoring a call exists among the services subscribed to by the called party according to the service subscription information obtained by the perceiving module; and
a second judging submodule, adapted to judge whether the service determined by the first judging submodule can be triggered.

19. The entity of claim 17, wherein the judging module comprises:
a third judging submodule, adapted to judge whether a service influential in anchoring a call can be triggered according to the service processing information of the subscribed service obtained by the perceiving module.

20. The entity of claim 17, wherein the anchoring optimization module is adapted to optimize the call anchoring by releasing the anchored VCC resources; or by releasing the anchored VCC resources and occupied call resources; or by terminating the anchoring for the call.

21. A system for optimizing call anchoring in Voice Call Continuity (VCC), comprising:
a VCC function entity, a VCC Anchoring Optimization (VAO) function entity interacting with the VCC function entity, the VAO function entity being adapted to obtain service information of a called party, and optimize a call anchoring when the service influential in anchoring the call can be triggered according to the service information.

22. The system of claim 21, wherein, in the case that the VAO function entity works with a Network Domain Selection (NeDS) function entity which is in the VCC function entity to optimize the call anchoring, the VAO function entity is adapted to release the anchored VCC resources to optimize the call anchoring;
in the case that the VAO function entity works with a Service Control Point (SCP) function entity which is in the VCC function entity to optimize the call anchoring, the VAO function entity is adapted to terminate the anchoring of the call or release the anchored VCC resources to optimize the call anchoring; and
in the case that the VAO function entity works with a Special Resource Function (SRF) entity to optimize the call anchoring, the VAO function entity is adapted to release the anchored VCC resources; or release the anchored VCC resources and occupied call resources; or terminate the anchoring of the call to optimize the call anchoring.

23. The system of claim 21, further comprising a routing control entity interacting with the VCC function entity through interface, adapted to reroute a call according to a received redirection message.
